(19) United States
(12) Patent Application Publication
(10) Pub. No.: US 2022/0131807 A1
(43) Pub. Date: Apr. 28, 2022

(54) IDENTIFICATION OF FAULTY SD-WAN SEGMENT

(71) Applicant: VMware, Inc., Palo Alto, CA (US)

(72) Inventors: Anand Srinivas, San Francisco, CA (US); Stephen Craig Connors, San Jose, CA (US); Murtaza Zafer, San Jose, CA (US); Goutham Vijayakumar, Newark, CA (US); Raja Alomari, Redwood City, CA (US)

(21) Appl. No.: 17/194,038

(22) Filed: Mar. 5, 2021

Related U.S. Application Data
(60) Provisional application No. 63/106,788, filed on Oct. 28, 2020.

(51) Int. Cl. H04L 12/851; H04L 12/26; H04L 12/707; H04L 12/833

(52) U.S. Cl. CPC H04L 47/2483; H04L 43/04; H04L 43/0864; H04L 47/2458; H04L 45/22

(57) ABSTRACT

Some embodiments provide a method for managing a network. Based on a first set of flow statistics received from network elements in the network, the method identifies a data message flow with degraded performance. The data message flow follows a path, between a first endpoint and a second endpoint through a set of the network elements in the network, that includes multiple segments. The method uses a second set of flow statistics received from the set of network elements to identify a particular segment of the path as a most likely contributor to the degraded performance of the particular flow. The method initiates a corrective action to resolve the degraded performance for the data message flow based on the identification of the particular segment.

### BACKGROUND

Software-defined wide area networks (SD-WANs) are growing more prevalent for enterprises as a more flexible and programmable networking model in place of traditional hardware infrastructure-based WANs. These SD-WANs often carry data traffic for many applications (e.g., Office365, Slack, etc.) that client devices (e.g., operating in branch offices or externally) access. If traffic for one of these applications is too slow, this can affect productivity for the enterprise. Network problems with these applications can be identified (e.g., by the user of the application) and manually pinpointed, but this can be a slow process. As such, better techniques for identifying and correcting problems in the SD-WAN are needed.

### BRIEF SUMMARY

Some embodiments provide a method for identifying a particular network segment most likely contributing to degraded performance of a data message flow in a network. The method of some embodiments first identifies the data message flow as suffering from degraded performance using a first set of statistics received from network elements of the network, then uses a second set of statistics to identify the particular network segment contributing to this degraded performance. Upon identifying the particular segment, the method initiates corrective action to resolve the degraded performance for the data message flow.

The network, in some embodiments, is a software-defined wide area network (SD-WAN). The SD-WAN of some embodiments links together an enterprise's own datacenters (e.g., one or more primary on-premises datacenters, one or more branch offices) along with external third-party private and/or public cloud datacenters. Certain forwarding elements in each of the datacenters spanned by the SD-WAN are managed by a controller cluster that configures these forwarding elements to implement the SD-WAN. For instance, in some embodiments, SD-WAN edge nodes are located in the branch offices to enable devices in the branch offices (e.g., individual computers, mobile devices, etc.) to connect to enterprise application servers located elsewhere in other datacenters. SD-WAN gateways are located in the clouds to (i) provide SD-WAN connections to machines (e.g., application servers, storage, etc.) located in the clouds and (ii) operate as intermediate SD-WAN forwarding elements between other datacenters. In addition, the network of some embodiments may include one or more SD-WAN hubs located in a cloud or enterprise (on-premises) datacenter. Edge nodes and gateways may connect directly with each other or connect through intermediate hubs and/or other gateways, in different embodiments.

In some embodiments, each data message flow in the SD-WAN has two endpoints and passes through one or more network elements (i.e., SD-WAN elements, such as the edges, gateways, and hubs). For an application flow, these endpoints might be a client (e.g., a user device such as a mobile device, laptop or desktop computer, etc.) and a server (e.g., a container, virtual machine, physical bare metal computer, etc.). Data messages from one of the endpoints pass through one or more of the network elements, which forward (e.g., route) the data messages along connection links (e.g., tunnels) to eventually reach the destination endpoint. For instance, a client device in a branch office might transmit data messages for a particular application server (identified by an IP address, hostname, etc.) to a first edge device at the branch office, which uses a particular link to forward the data messages to a second edge device at an on-premises enterprise datacenter. The second edge device forwards the data messages to an application server at the enterprise datacenter. Return data messages from the application server follow the opposite path.

Each portion of a path either (i) between an endpoint and its closest network element on the path or (ii) between two subsequent network elements is referred to as a network segment. Thus, in the above example, the path has three segments: (i) the local area network (LAN) between the client and the first edge device, (ii) the WAN between the two edge devices, and (iii) the LAN between the second edge device and the application server. In general, each path will have at least two segments, and the number of segments along a given path is one greater than the number of network elements in the path.

In some embodiments, the identification of flows with degraded performance and identification of network segments causing that degraded performance is performed by a centralized analysis engine. This analysis engine may operate on a single device (e.g., in one of the datacenters linked by the SD-WAN) or on a cluster (e.g., in one or more of these datacenters). In some embodiments, the analysis engine operates alongside the SD-WAN controller (e.g., on the same device or same cluster of devices).

The analysis engine of some embodiments receives flow statistics from each of the network elements in the SD-WAN. Specifically, each SD-WAN network element provides to the analysis engine statistics for each of the flows processed by that element. In some embodiments, the network element determines these flow statistics itself, while in other embodiments the network element mirrors its data messages to a statistics collector that determines the flow statistics and regularly reports them to the analysis engine. In some embodiments, the network elements provide different statistics for different types of flows. For instance, the statistics for bidirectional flows (e.g., TCP flows) might include round trip time (i.e., between the network element and each of the endpoints), the number of data messages received at the network element in each direction, the number of retransmitted data messages received at the network element in each direction, as well as the number of various different types of connection-initiation and connection-teardown related messages received. For unidirectional flows (e.g., UDP flows), the flow statistics can include jitter and, if the network element is available to extract sequence numbers from the data messages, packet loss. If the network elements are known to be synchronized, data message arrival times can be reported, which the analysis engine uses to compute latencies in some embodiments.

In addition to receiving flow statistics from the network elements, the analysis engine also receives network topology information (e.g., from the SD-WAN controller cluster). The analysis engine can identify the path (and therefore the segments) for each data message flow by matching flows across network elements using flow identification information to identify all of the network elements through which a data message flow passes and using the topology information to construct the path through these network elements. This path information allows the analysis engine to identify the segments and compute various metrics (from the flow statistics) on a per-segment basis that allows the engine to identify the specific segment (or segments) contributing to degraded performance of a data message flow.

Some embodiments identify the flows using 5-tuples (i.e., source and destination network addresses, source and destination transport layer ports, and transport protocol). In addition, some embodiments also specify an application identifier for each flow (or at least a subset of the flows) if this information can be derived (e.g., from a network address, DNS information, or a hostname associated with a particular application). Application identifiers allow for the analysis engine to identify if many data message flows for the same application are having similar performance issues.

To identify a data message flow with degraded performance, the analysis engine of some embodiments identifies when certain metrics for a flow pass a threshold value and/or when certain metrics change by at least a threshold amount from a baseline determined for that flow. For example, some embodiments identify a flow as having degraded performance if the number of zero-window events or the number of retransmits per data message increases above a threshold. To identify deviations, some embodiments analyze flow statistics over a first period of time in order to generate baselines for various metrics for each ongoing data message flow (e.g., round-trip time in one or both directions, number of retransmits per data message, jitter, etc.). By comparing updated statistics (or calculated metrics) for each of these flows to the baseline, the analysis engine can identify significant deviations from the baselines and therefore identify flows with degraded performance.

Once the analysis engine identifies a particular data message flow with degraded performance, the engine uses the statistics to identify one (or more) segments that is most likely to be causing the problem. Here, the analysis engine of some embodiments uses a combination of the statistics and/or computed metrics used to identify the degraded performance as well as other statistics and/or metrics to identify the specific problem segment. Specifically, some embodiments compute metrics particular to each segment. For instance, some embodiments compute the isolated round trip time on a segment. For the segment between a flow endpoint (e.g., the client device or application server) and the network element (e.g., an edge node) closest to that endpoint, some embodiments simply use the round-trip time for the segment reported by that network element. For a segment between two network elements, some embodiments use the differences in round trip time, for each endpoint, between (i) the endpoint and the further of the two network elements from the endpoint and (ii) the endpoint and the closer of the two network elements to the endpoint. Using these and other segment-specific metrics, the analysis engine can determine the segment that is most likely contributing to the degraded performance of the flow. Some embodiments also account for the expectations for different segments. For instance, if two edge nodes are located a large geographic distance apart, the expectation may be that the round-trip time on the segment between those edge nodes will be larger than the round-trip time within a branch office, even when operating correctly.

As mentioned, some embodiments initiate corrective action once the likely problem segment is identified. Some embodiments provide information to an administrator (e.g., via a user interface) specifying the problem segment and, if available, the application. When possible, this information is provided in terms of a human-understandable segment name (e.g., “client LAN”, “WAN between branch office X and on-prem datacenter”, “application server LAN”, etc.).

Some embodiments, as an alternative or in addition to notifying the administrator, automatically take corrective actions within the network. The type of action might depend on which segment is likely causing the problem. For example, if the problem appears to be caused by the application server LAN segment (i.e., the segment between the application server and its edge node), some embodiments configure the network elements to route traffic to another application server located at a different datacenter. If the problem lies within the SD-WAN, different embodiments might request an increase in underlay bandwidth, change the priority of the data flow (or all data flows for the application), or route the traffic differently within the WAN (e.g., on a different overlay that uses either a different link between the same network elements or a different path with a different set of network elements).

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates an SD-WAN that connects multiple branch offices for an entity with an enterprise datacenter and multiple clouds.

FIG. 2 conceptually illustrates a path between a client machine located in a branch office and an application server located in an enterprise datacenter.

FIG. 3 conceptually illustrates an SD-WAN of some embodiments with an analysis engine that receives flow statistics from the network elements of the SD-WAN.

FIG. 4 conceptually illustrates the architecture of and data flow within an analysis engine of some embodiments in more detail.

FIG. 5 conceptually illustrates a process of some embodiments for determining the most likely problem segment for a data message flow with degraded performance and initiating corrective action to improve the performance of the data message flow.

FIG. 6 illustrates statistics for a data message flow as the flow performance degrades, as well as a corrective action taken to improve flow performance.

FIG. 7 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method for identifying a particular network segment most likely contributing to degraded performance of a data message flow in a network. The method of some embodiments first identifies the data message flow as suffering from degraded performance using a first set of statistics received from network elements of the network, then uses a second set of statistics to identify the particular network segment contributing to this degraded performance. Upon identifying the particular segment, the method initiates corrective action to resolve the degraded performance for the data message flow.

The network, in some embodiments, is a software-defined wide area network (SD-WAN). The SD-WAN of some embodiments links together an enterprise's own datacenters (e.g., one or more primary on-premises datacenters, one or more branch offices) along with external third-party private and/or public cloud datacenters. Certain forwarding elements in each of the datacenters spanned by the SD-WAN are managed by a controller cluster that configures these forwarding elements to implement the SD-WAN.

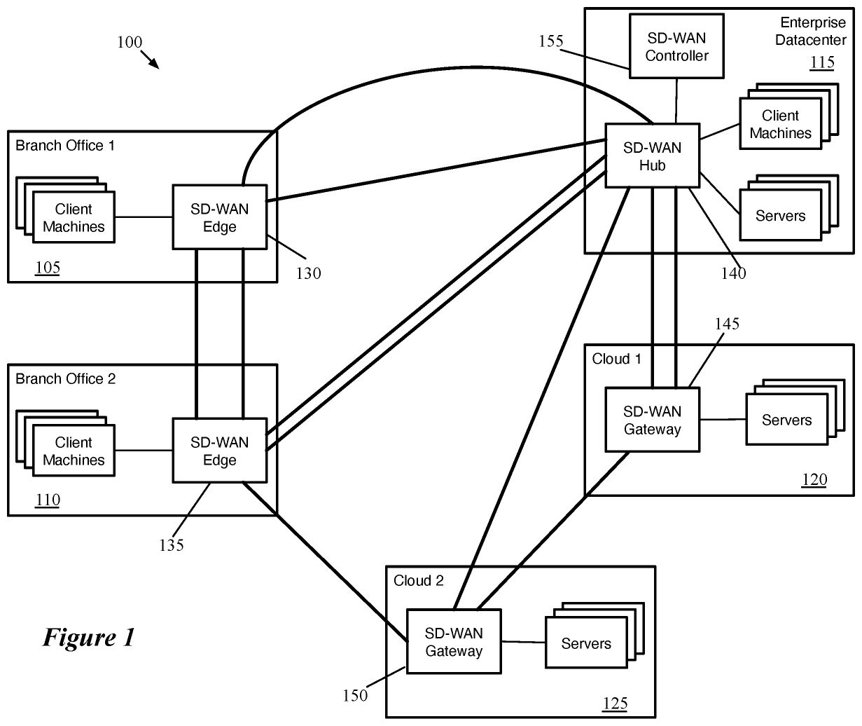

FIG. 1 conceptually illustrates an SD-WAN 100 that connects multiple branch offices for an entity with an enterprise datacenter and multiple clouds. As shown, in this example the SD-WAN connects machines in two branch offices 105 and 110, an on-premises enterprise datacenter 115, and two clouds (e.g., public cloud datacenters) 120 and 125. The SD-WAN 100 is implemented by edge forwarding nodes 130 and 135 at the branch offices 105 and 110, respectively, a hub node 140 at the enterprise datacenter 115, and gateways 145 and 150 at the clouds 120 and 125, respectively.

As in this example, the SD-WAN of some embodiments includes a combination of edge nodes, gateways, and hubs. Edge nodes, in some embodiments, are hardware devices deployed in an entity's multi-machine datacenters (e.g., branch offices, enterprise datacenters, etc.), and provide links to other SD-WAN network elements. In some embodiments, gateways are deployed in cloud datacenters to (i) provide SD-WAN connections to machines (e.g., application servers, storage, etc.) located in these clouds and (ii) operate as intermediate SD-WAN network elements between other datacenters. Some embodiments also include one or more hubs (e.g., located at an on-premises primary enterprise datacenter), which are also hardware devices that connect multiple other SD-WAN network elements to each other. In different embodiments, the hub acts as the center of a hub-and-spoke SD-WAN network structure, while in other embodiments the edge devices and gateways are able to link directly with each other and no SD-WAN hub is required. In the example shown in FIG. 1, the hub device 140 connects to all of the other SD-WAN network elements 130, 135, 145, and 150, but some of these network elements also have direct links to each other.

It should be noted that while this example shows a single SD-WAN network element at each of the datacenters, in some embodiments multiple SD-WAN network elements are located at some or all of the datacenters connected by the SD-WAN. For instance, some embodiments include multiple edges/hubs at each branch office and/or enterprise datacenter in a high-availability (HA) arrangement for redundancy. In addition, some embodiments include multiple SD-WAN gateways in some or all of the public clouds, either in an HA arrangement or as multiple separate gateways providing different connections to different additional datacenters.

As shown, the SD-WAN 100 enables client machines (e.g., laptop/desktop computers, mobile devices, virtual machines (VMs), containers, etc.) located in the branch offices 105 and 110 as well as the enterprise datacenter 115 to connect to application servers (e.g., VMs, bare metal computers, containers, etc.) located in the enterprise datacenter 115 as well as the clouds 120 and 125. It should be noted that in some embodiments the client machines may be located in the clouds (e.g., as VMs or containers) and application servers can be located in the branch offices. The devices located within the same datacenter are able to communicate without requiring the SD-WAN, in some embodiments (e.g., via a local area network (LAN) through which these devices communicate with each other and their respective local SD-WAN edge, gateway, or hub).

The SD-WAN network elements connect to each other through one or more secure connection links (e.g., encrypted tunnels). In many cases, an edge node has multiple such connection links to a hub, another edge node, or a gateway. For instance, in the figure, the edge node 130 has two connection links to the other edge node 135 as well as two connection links to the hub 140. Similarly, the hub 140 has two connection links to the gateway 145. In some embodiments, when an edge node or hub is connected by multiple links to another network element, each connection link is associated with a different physical network link connected to the edge node. For instance, an edge node in some embodiments might have one or more commercial broadband links (e.g., a cable modem, fiber optic link, etc.) to access the internet, a multiprotocol label switching (MPLS) link to access external networks through an MPLS provider's network, and/or a wireless cellular link (e.g., a 5G LTE network).

FIG. 1 also illustrates an SD-WAN controller 155 located in the enterprise datacenter 115. In different embodiments, this may be a single controller or a controller cluster. The controller 155 serves as a central point for managing (e.g., defining and modifying) configuration data that is provided to the SD-WAN network elements 130-150 to configure the operations of these devices for implementing the SD-WAN (e.g., routing, tunneling, etc.). In some embodiments, the controller 155 directs the network elements 130-150 to connect with specific other network elements via specific links (e.g., for the edge node 130 to connect with the edge node 135 and the hub 140, but not either of the gateways 145 and 150). While this figure shows the controller 155 located in the enterprise datacenter 115, in some embodiments the controller(s) can reside in one or more of the other datacenters (e.g., including the branch offices and/or public clouds).

The SD-WAN allows client machines (e.g., in branch offices or other datacenters, or even located outside of the datacenters and connected via a virtual private network) to securely access server machines located elsewhere. For instance, many enterprises will have application servers for applications such as SharePoint, Slack, etc. that operate in cloud datacenters or in an enterprise datacenter, which employees located in various geographic locations need to access. These client machines communicate with the servers by exchanging data messages in ongoing data message flows. A data message flow is an ongoing series of data messages (either unidirectional or bidirectional) with a set of properties in common, typically defined by a 5-tuple of source and destination network address, source and destination transport layer port, and transport layer protocol).

In some embodiments, each data message flow in the SD-WAN has two endpoints and passes through one or more SD-WAN network elements (e.g., the edges, gateways, and/or hubs). For an application flow, these endpoints might be a client machine (e.g., a user device such as a mobile device, laptop or desktop computer, etc.) and a server (e.g., a container, virtual machine, physical bare metal computer, etc.). Data messages from one of the endpoints pass through one or more of the SD-WAN network elements, which forward (e.g., route) the data messages along connection links to eventually reach the destination endpoint.

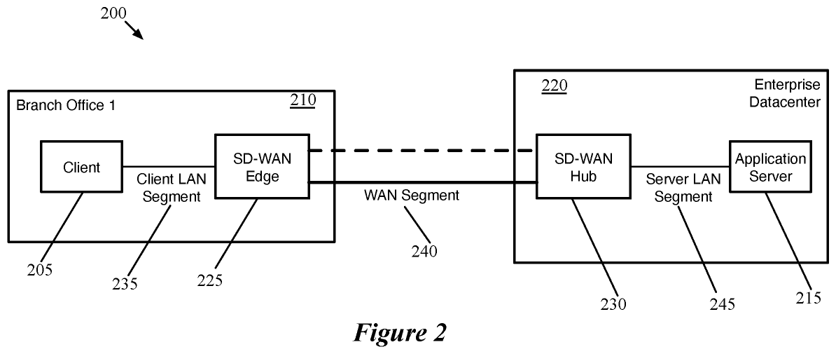

FIG. 2 conceptually illustrates such a path 200 between a client machine 205 located in a branch office 210 and an application server 215 located in an enterprise datacenter 220. In this example, data messages from the client machine 205 are sent (through a LAN) to an SD-WAN edge node 225 also located in the branch office 210. These data messages are directed to a particular application server or set of application servers (identified by an IP address, hostname, etc.). In some embodiments, the edge node 225 is configured (e.g., by the SD-WAN controller) to use a specific destination application server 215 for data message flows directed to the application. The edge node 225 uses one of two links (secure tunnels) to send these data messages to an SD-WAN hub node 230 in the enterprise datacenter 220. The hub 230 decapsulates the data messages received via this link and transmits the data messages to the application server 215 (e.g., via another LAN within the enterprise datacenter 220). Return data messages from the application server 215 follow the reverse path to the client machine 205.

Each portion of a path either (i) between an endpoint and its closest network element on the path or (ii) between two subsequent network elements is referred to as a network segment. Thus, in the example of FIG. 2, the path 200 has three segments: (i) the client LAN segment 235 between the client machine 205 and the edge node 225, (ii) the WAN segment 240 between the edge node 225 and the hub 230, and (iii) the server LAN segment 245 between the hub 230 and the application server 215. In general, each path through the SD-WAN will have at least two segments (on either side of a single SD-WAN network element), and the number of segments along a given path will be one greater than the number of SD-WAN network elements in the path.

In some embodiments, the identification of flows with degraded performance and identification of network segments causing that degraded performance is performed by a centralized analysis engine. This analysis engine may operate on a single device (e.g., in one of the datacenters linked by the SD-WAN) or on a cluster (e.g., in one or more of these datacenters). In some embodiments, the analysis engine operates alongside the SD-WAN controller (e.g., on the same device or same cluster of devices). The analysis engine of some embodiments receives flow statistics from each of the network elements in the SD-WAN.

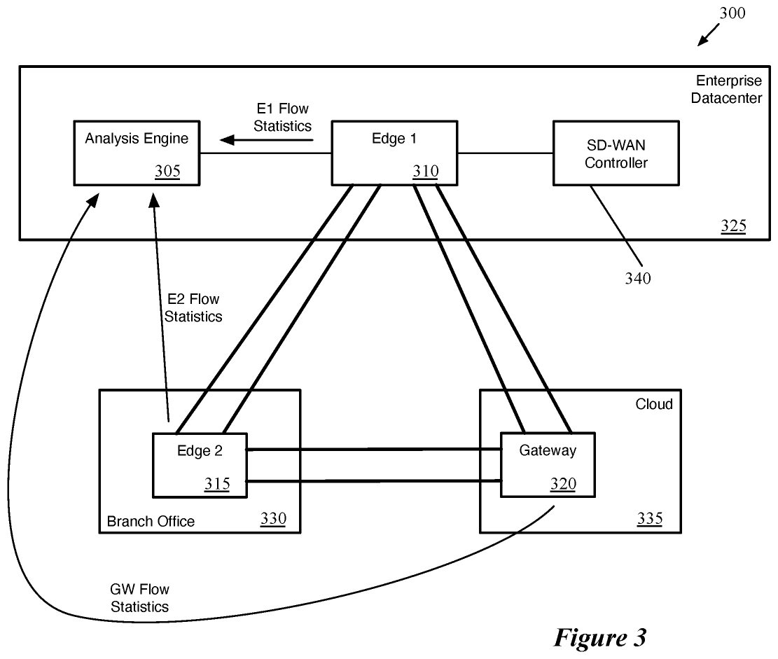

FIG. 3 conceptually illustrates an SD-WAN 300 of some embodiments with an analysis engine 305 that receives flow statistics from the network elements of the SD-WAN. The SD-WAN 300 includes three network elements: two edge nodes 310 and 315 (located respectively at an enterprise datacenter 325 and branch office 330), and a gateway 320 (located in a cloud datacenter 335). In addition, both an SD-WAN controller 340 and the analysis engine 305 are located at the enterprise datacenter 325. Though shown separately, in some embodiments the controller 340 and the analysis engine 305 execute on the same machines (or set of machines). In some such embodiments, the analysis engine 305 is actually part of the SD-WAN controller 340. Furthermore, though the analysis engine 305 and controller 340 are shown as connected to the edge node 310, in some embodiments (even if operating separately) these two entities communicate directly (i.e., not through the SD-WAN).

As shown in this figure, each of the SD-WAN network elements 310-320 provides to the analysis engine 305 statistics for each of the data message flows processed by that element. In some embodiments, the remote network elements 315 and 320 provide these flow statistics to the analysis engine 305 through the SD-WAN 300, while in other embodiments these network elements 315 and 320 provide the flow statistics via other communication methods (e.g., through public or private networks separate from the SD-WAN).

In some embodiments, each of the network elements 310-320 determines these flow statistics itself. That is, the network elements are configured to analyze each data message, identify the flow to which the data message belongs, generate statistics for each data message flow, and provide these statistics to the analysis engine 305. In some embodiments, the network elements also identify the application to which each data message flow (or some of the flows) relates and provide this information along with the set of flow statistics for each flow. In other embodiments, some or all of the network elements in the SD-WAN mirror their data messages to a statistics collector that analyzes the mirrored data messages to determine flow statistics and reports these flow statistics to the analysis engine 305.

In some embodiments, the network elements provide different statistics for different types of flows. For instance, the statistics for bidirectional flows might include round trip time (i.e., between the network element and each of the endpoints), the number of data messages received at the network element in each direction, and the number of retransmitted data messages received at the network element in each direction. In addition, for specific transport layer protocols, the flow statistics could include the number of protocol-specific messages related to the connection initiation, teardown, reset, etc. (e.g., SYN, SYN-ACK, RST, and FIN messages for TCP flows, as well as zero-window events that occur when a buffer at one endpoint or the other starts to fill up). For unidirectional flows (e.g., UDP flows), the flow statistics in some embodiments might include jitter and, if the network element is available to extract sequence numbers from the data messages, packet loss. If the network elements are known to be synchronized, data message arrival times can be reported, which the analysis engine 305 uses to compute latencies in some embodiments.

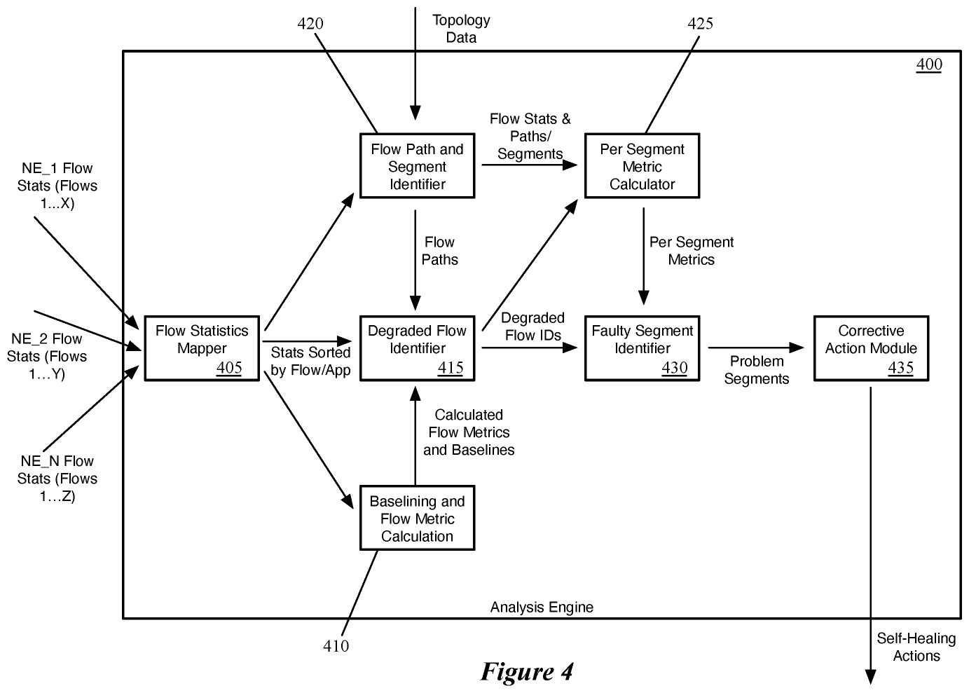

FIG. 4 conceptually illustrates the architecture of and data flow within an analysis engine 400 of some embodiments in more detail. The analysis engine 400 includes a flow statistics mapper 405, a baselining and flow metric calculation module 410, a degraded flow identifier 415, a flow path and segment identifier 420, a per segment metric calculator 425, a faulty segment identifier 430, and a corrective action module 435. It should be understood that in different embodiments the analytics engine architecture may be different, in that some modules may be combined (e.g., the baselining and flow metric calculation module 410 and degraded flow identifier 415 could be part of a single machine-learning engine), some modules shown may actually include multiple separate modules (e.g., separate baselining and flow metric calculation modules), the modules may operate on data in a different order, or the analytics engine 400 could include different modules not shown in this example.

As shown, the analytics engine 400 receives flow statistics from each network element in the SD-WAN. In some embodiments, this includes statistics for all of the flows (or a subset of the flows) processed by each of these network elements. Unless every flow is processed by all of the network elements in the SD-WAN (which would typically only be the case for a very simple network), different network elements provide statistics for different numbers of flows. In some embodiments, each network elements provides flow statistics to the analytics engine 400 at regular time intervals (e.g., every second, every 5 seconds, every minute, etc.), with the statistics providing information for the most recent time interval (e.g., the number of packets for a given flow in the time interval, the average round-trip time between the network element and one or both endpoints for data messages belonging to the flow over the time interval, etc.).

The flow statistics mapper 405 of some embodiments groups the flow statistics from multiple network elements by flow and/or application. In some embodiments, the network elements specify the flow statistics using 5-tuples (i.e., source and destination network addresses, source and destination transport layer ports, and transport protocol), and the flow statistics mapper 405 uses this data to match statistics for the same flow from different network elements. In addition, some embodiments also specify an application identifier for each flow (or at least a subset of the flows) if this information can be derived by the network element (e.g., from the network address, DNS information, or a hostname associated with a particular application). In some embodiments, this requires the network element to inspect higher-layer information (e.g., layer 7 data) as opposed to just the L2-L4 data of the data messages. Application identifiers allow for the analysis engine to identify if many data message flows for the same application are having similar performance issues.

The flow statistics mapper 405 provides the sorted flow statistics to the baselining and flow metric calculation module 410, the degraded flow identifier 415, and the flow path and segment identifier 420. In addition to receiving flow statistics from the network elements, the analysis engine also receives network topology information (e.g., from the SD-WAN controller cluster). The flow path and segment identifier 420 uses this topology information along with the statistics from the flow statistics mapper 405 to determine the path for each data message flow and therefore the segments of each flow. That is, with the flow statistics mapper 405 specifying the list of network elements that provide statistics for a particular data message flow, the flow path and segment identifier 420 can use the topology data to construct the order through which the flow passes through the network elements. In some embodiments, the flow path and segment identifier 420 provides the flow path information to the degraded flow identifier 415 and the path and segment information to the per segment metric calculator 425. Though not shown, this information may also be provided to other modules (e.g., the baselining and flow metric calculation module 410, the faulty segment identifier 430, and/or the corrective action module 435).

To identify a data message flow with degraded performance, the degraded flow identifier 415 of some embodiments identifies when certain metrics for a flow pass a threshold value and/or when certain metrics change by at least a threshold amount from a baseline determined for that flow. The baselining and flow metric calculation module 410 of some embodiments computes metrics based on the raw flow statistics and determines baselines for each flow. These computed metrics might include, for example, the ratio of the number of data messages observed by a network element in a particular direction (e.g., client to server or server to client) divided by the number of retransmitted data messages observed by the network element in the particular direction. For both computed metrics and raw flow statistics received from the network element, the baselining module 410 determines baselines for each flow. In some embodiments, the baselining module 410 uses machine-learning techniques to build up these baselines based on the data received from network elements over a period of time.

These baselines enable the degraded flow identifier 415 to determine when the performance of a particular flow is degraded. If certain flow statistics or computed metrics for an ongoing data message flow change by a particular amount from the computed baseline (e.g., by a threshold percentage in a particular direction), then the degraded flow identifier 415 of some embodiments identifies the data message flow as having degraded performance. For instance, if the number of retransmits per data message, round-trip time in a particular direction, etc. increases by a threshold percentage for a particular flow, then the degraded flow identifier 415 identifies the flow as having degraded performance. Similarly, if certain statistics or computed metrics for a data message flow cross an absolute threshold value, then the degraded flow identifier 415 of some embodiments identifies the data message flow as having degraded performance. Examples of such statistics or metrics could be the number of zero-window events reported for a time interval increasing above a threshold, packet loss passing a threshold, etc.

When the degraded flow identifier 415 determines that a particular data message flow has degraded performance, the analysis engine 400 uses the statistics for the data flow to identify one (or more) segments that is most likely to be causing the degraded performance. As shown, the degraded flow identifier 415 provides identities of these flows to the per segment metric calculator 425 and the faulty segment identifier 430.

The per segment metric calculator 425 uses the segment information for the specified flows received from the flow path and segment identifier 420 to determine specific segments for each degraded flow and calculates various metrics for each segment. In some embodiments, the per segment metric calculator also calculates historical data for these segments in order to identify where various metrics have gotten worse, especially if the flow degradation was identified based on deviation from historical baselines.

For instance, some embodiments compute the isolated round trip time on a segment (at least for bidirectional flows). For the segment between a flow endpoint (e.g., the client device or application server) and the network element (e.g., an edge node) closest to that endpoint, some embodiments simply use the round-trip time for the segment reported by that network element. For a segment between two network elements, some embodiments use the differences in round trip time, for each endpoint, between (i) the endpoint and the further of the two network elements from the endpoint and (ii) the endpoint and the closer of the two network elements to the endpoint. Other per segment metrics might include, e.g., the number of retransmits per data message seen by each of the network elements that forms the segment, a difference in number of overall data messages in each direction seen by each of the network elements, the difference in packet loss, etc.

The per segment metric calculator 425 provides the per-segment data to the faulty segment identifier 430 in some embodiments, which uses these metrics to determine the segment that is most likely contributing to the degraded performance of the data message flow. For instance, if historical baselines show that the round-trip time on a particular segment has slowed down while the other segments are mostly unchanged, then that particular segment is most likely contributing to the degraded performance of the flow. In some embodiments, the faulty segment identifier 430 also accounts for the expectations for different segments (e.g., based on data from the flow path and segment identifier 420). For instance, if two edge nodes are located a large geographic distance apart, the expectation may be that the round-trip time on the segment between those edge nodes will be larger than the round-trip time within a branch office, even when operating correctly.

The faulty segment identifier 430 provides indications of the segments causing problems to the corrective action module 435. The corrective action module 435 initiates corrective action to improve performance of the degraded data message flow. To initiate this corrective action, some embodiments provide information to an administrator (e.g., via a user interface) specifying the problem segment and, if available, the application. When possible, the corrective action module 435 provides this information in terms of a human-understandable segment name (e.g., “client LAN”, “WAN between branch office X and on-prem datacenter”, “application server LAN”, etc.). In order to provide this detailed information, the corrective action module 435 receives topology data and/or the flow paths and segments data generated by the flow path and segment identifier 420.

Some embodiments, as an alternative or in addition to notifying the administrator, automatically initiate corrective actions within the network. The type of action might depend on which segment has been identified as the most likely cause of the problem. For example, if the problem appears to be caused by the application server LAN segment (i.e., the segment between the application server and its edge node), some embodiments configure the network elements to route traffic to another application server located at a different datacenter. If the problem lies within the SD-WAN, different embodiments might request an increase in underlay bandwidth, change the priority of the data flow (or all data flows for the application), or route the traffic differently within the WAN (e.g., on a different overlay that uses either a different link between the same network elements or a different path with a different set of network elements).

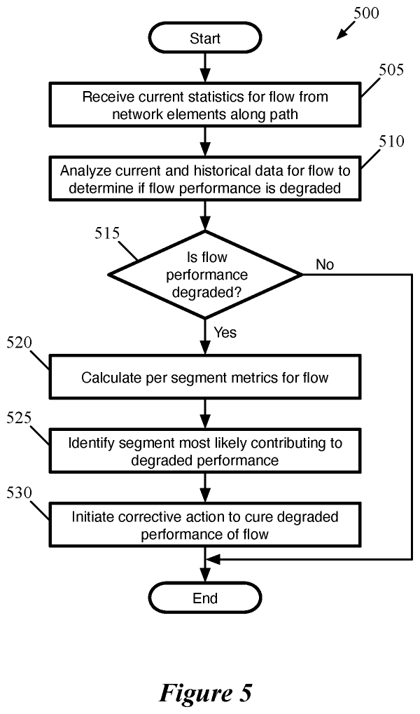

FIG. 5 conceptually illustrates a process 500 of some embodiments for determining the most likely problem segment for a data message flow with degraded performance and initiating corrective action to improve the performance of the data message flow. In some embodiments, the process 500 is performed by an analysis engine such as that shown in FIG. 4 (e.g., by some or all of the modules of such an analysis engine). It should be noted that the process 500 is a process performed by an analysis engine, in some embodiments, for a single data flow. The analysis engine of some embodiments regularly performs this process (or a similar process) in parallel for many data flows in the SD-WAN in order to identify the faulty segments.

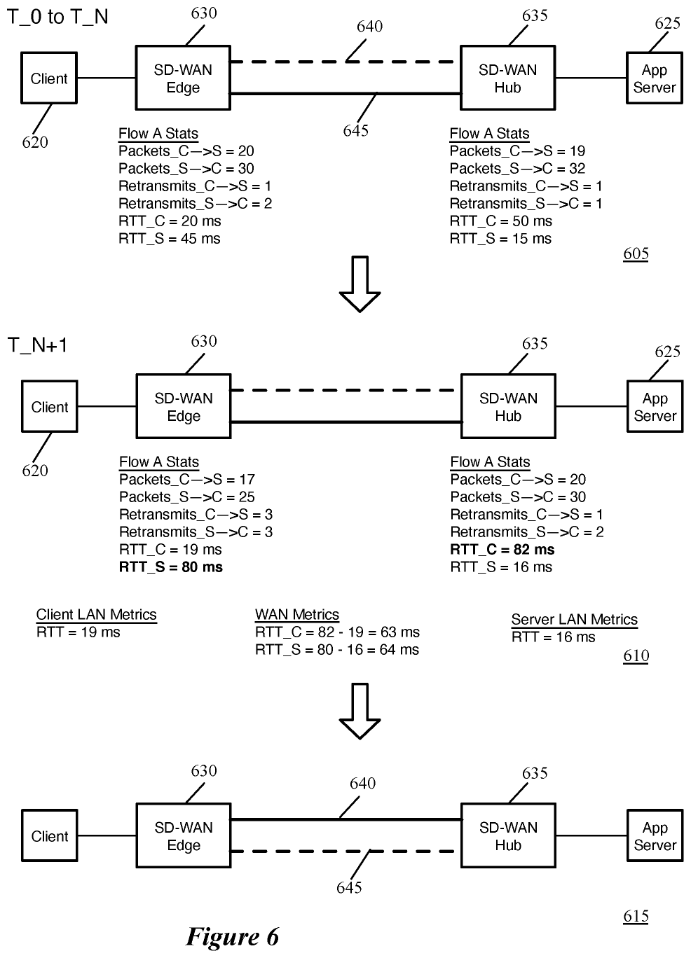

The process 500 will be described in part by reference to FIG. 6, which illustrates statistics for a data message flow as the flow performance degrades, as well as a corrective action taken to improve flow performance, over three stages 605-615. As shown in the first stage 605, the flow between a client 620 and an application server 625 passes through an SD-WAN edge node 630 and an SD-WAN hub 635, such that the path for this data flow includes three segments. Two different links 640 and 645 exist between the two SD-WAN network elements 630 and 635, with the current path using the second link 645.

This first stage 605 also shows historical baseline statistics reported by the two SD-WAN network elements 630 and 635 from time T₀ to time T_{N}. As shown, the edge node 630 has historically reported 20 packets per time period (e.g., per second) from the client to the server and 30 packets from the server to the client, with 1 retransmit per time period from the client and 2 retransmits per time period from the server. The average round-trip time from the edge node 630 to the client 620 (on the client LAN segment) has been 20 ms and the average round-trip time from the edge node 630 to the application server 625 has been 45 ms. The hub node 635 has historically reported 19 packets per time period (e.g., per second) from the client to the server and 32 packets from the server to the client, with 1 retransmit per time period from the client and 1 retransmit per time period from the server (the disparity in the number of packets in each direction at the two network elements might be due to some amount of packet loss on the WAN segment). The average round-trip time from the hub 635 to the application server 625 (on the server LAN segment) has been 15 ms and the average round-trip time from the hub 635 to the client 620 has been 50 ms.

Returning to FIG. 5, the process 500 begins by receiving (at 505) current statistics for a data message flow from the network elements (e.g., the SD-WAN network elements) along the path of the flow. In the example shown in FIG. 6, the second stage 610 illustrates new flow statistics received from the network elements 630 and 635 at time T_{N+1}. As shown, the edge node 630 reports 17 packets per time period from the client to the server and 25 packets from the server to the client, with 3 retransmits from the client and 3 retransmits per time period from the server. The average round-trip time from the edge node 630 to the client 620 during this time period is 19 ms and the average round-trip time from the edge node 630 to the application server 625 is 80 ms. The hub node 635 reports 20 packets per time period from the client to the server and 30 packets from the server to the client, with 1 retransmit from the client and 2 retransmits from the server. The average round-trip time from the hub 635 to the application server 625 is 16 ms and the average round-trip time from the hub 635 to the client 620 is 82 ms.

The process 500 analyzes (at 510) the current and historical data for the flow to determine if flow performance has been degraded. As described above, the analysis engine of some embodiments identifies when certain metrics for a flow pass a threshold value and/or when certain metrics change by at least a threshold amount from the baseline determined for that flow. The process 500 then determines (at 515) whether the flow performance has degraded. If not, the process ends as no additional action needs to be taken with regard to the particular data message flow (although the process will be repeated when the next set of statistics is received from the network elements). In the example of FIG. 6, the round-trip time between the edge node 630 and the application server 625 as well as the round-trip time between the hub 635 and the client 620 are well above the baseline, such that the flow performance can be considered to have degraded to a point requiring further analysis and corrective action.

If the flow performance is degraded, the process 500 calculates (at 520) per segment metrics for the flow. It should be noted that, while this process describes the per segment metrics as only being calculated for data message flows that are already identified as degraded, some embodiments calculate these metrics for each flow and use the per segment metrics as part of the analysis to determine whether the flow is degraded. The second stage 610 of FIG. 6 also shows the round-trip times calculated for each network segment. For the client LAN segment (between the client 620 and the edge node 630) the round-trip time reported by the edge node 630 is used. Similarly, for the server LAN segment (between the server 625 and the hub 635) the round-trip time reported by the hub 635 is used. Two round-trip times are calculated for the WAN segment between the two network elements 630 and 635. The first is the round-trip time from the hub 635 to the client 620 (82 ms) minus the round-trip time from the edge node 630 to the client 620 (19 ms), which comes out to 63 ms. The second is the round-trip time from the edge node 630 to the application server 625 (80 ms) minus the round-trip time from the hub 635 to the application server 625 (16 ms), which comes out to 64 ms.

Based on the per segment metrics, the process 500 identifies (at 525) the segment (or segments) most likely contributing to the degraded performance. Some embodiments use baseline per segment metrics, if available, to make this determination as well (i.e., by identifying the segment(s) where the round-trip time has increased). In the example shown in FIG. 6, the WAN segment between the two network elements 630 and 635 has is clearly the source of the degraded performance, with the round-trip time dramatically increasing on this segment while staying more or less constant on the client LAN and server LAN segments.

Finally, with the segment identified, the process 500 initiates (at 530) corrective action to cure the degraded performance of the flow, then ends. As described, some embodiments provide information to an administrator specifying the problem segment and, if available, the application. For instance, in the example of FIG. 6, such embodiments might provide a notification specifying a problem for the particular application to which the flow relates on the WAN segment between the particular edge nodes (possibly specifying the particular communications link 645). Some embodiments also (or in the alternative) initiate corrective actions within the network, such as configuring network elements to route traffic for the particular application to another application server at a different location, requesting an increase in underlay bandwidth, or routing the traffic on a different path (or different set of links) through the SD-WAN.

The third stage of FIG. 6 illustrates that the edge node 630 and hub 635 have been configured to use the other communications link 640 through the SD-WAN for the particular data flow, thereby reducing traffic on the link 645. As mentioned previously, these links might include commercial broadband links that access the internet, an MPLS link, or a wireless cellular link. If a different path was available between the edge node 630 and the hub 635 (e.g., via a gateway), some embodiments might automatically configure the network elements to route data messages for the flow via this alternative path.

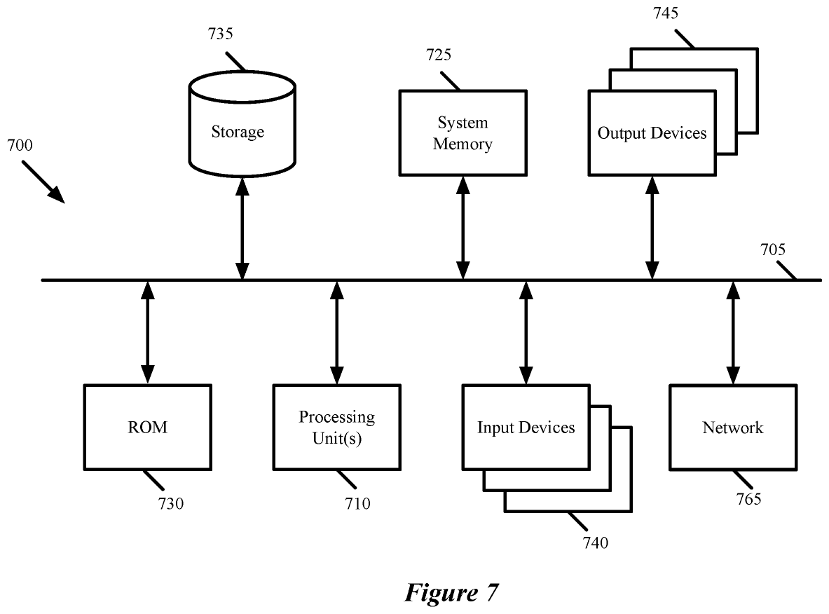

FIG. 7 conceptually illustrates an electronic system 700 with which some embodiments of the invention are implemented. The electronic system 700 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 700 includes a bus 705, processing unit(s) 710, a system memory 725, a read-only memory 730, a permanent storage device 735, input devices 740, and output devices 745.

The bus 705 collectively represents all system, peripheral, and chipset buses that communicatively connect the numerous internal devices of the electronic system 700. For instance, the bus 705 communicatively connects the processing unit(s) 710 with the read-only memory 730, the system memory 725, and the permanent storage device 735.

From these various memory units, the processing unit(s) 710 retrieve instructions to execute and data to process in order to execute the processes of the invention. The processing unit(s) may be a single processor or a multi-core processor in different embodiments.

The read-only-memory (ROM) 730 stores static data and instructions that are needed by the processing unit(s) 710 and other modules of the electronic system. The permanent storage device 735, on the other hand, is a read-and-write memory device. This device is a non-volatile memory unit that stores instructions and data even when the electronic system 700 is off. Some embodiments of the invention use a mass-storage device (such as a magnetic or optical disk and its corresponding disk drive) as the permanent storage device 735.

Other embodiments use a removable storage device (such as a floppy disk, flash drive, etc.) as the permanent storage device. Like the permanent storage device 735, the system memory 725 is a read-and-write memory device. However, unlike storage device 735, the system memory is a volatile read-and-write memory, such a random-access memory. The system memory stores some of the instructions and data that the processor needs at runtime. In some embodiments, the invention's processes are stored in the system memory 725, the permanent storage device 735, and/or the read-only memory 730. From these various memory units, the processing unit(s) 710 retrieve instructions to execute and data to process in order to execute the processes of some embodiments.

The bus 705 also connects to the input and output devices 740 and 745. The input devices enable the user to communicate information and select commands to the electronic system. The input devices 740 include alphanumeric keyboards and pointing devices (also called “cursor control devices”). The output devices 745 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 7, bus 705 also couples electronic system 700 to a network 765 through a network adapter (not shown). In this manner, the computer can be a part of a network of computers (such as a local area network (“LAN”), a wide area network (“WAN”), or an Intranet, or a network of networks, such as the Internet. Any or all components of electronic system 700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, is a non-VM DCN that includes a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures (including FIG. 5) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

We claim:

1. A method for managing a network, the method comprising:
based on a first set of flow statistics received from a plurality of network elements in the network, identifying a data message flow with degraded performance, the data message flow following a path between a first endpoint and a second endpoint through a set of the network elements in the network, the path comprising a plurality of segments;
using a second set of flow statistics received from the set of network elements to identify a particular segment of the path as a most likely contributor to the degraded performance of the particular flow; and
initiating a corrective action to resolve the degraded performance for the data message flow based on the identification of the particular segment.

2. The method of claim 1, wherein each respective segment of the path comprises a portion of the network between a respective pair of subsequent network elements along the path.

3. The method of claim 2, wherein a number of segments in the path is one greater than a number of network elements along the path.

4. The method of claim 1, wherein the network is a software-defined wide area network (SD-WAN) and the network elements implement the SD-WAN.

5. The method of claim 4, wherein the network elements include at least one of edges located at branch offices, hubs located at enterprise datacenters, and gateways located in public clouds.

6. The method of claim 4, wherein the network elements are managed by a set of SD-WAN controllers.

7. The method of claim 1, wherein the set of network elements is a subset of the plurality of network elements, the set of network elements comprising only network elements along the path between the first and second endpoints.

8. The method of claim 7 further comprising receiving, from each respective network element of the plurality of network elements, flow statistics for each data message flow of a respective set of data message flows processed by the respective network element.

9. The method of claim 8 further comprising analyzing flow statistics for a plurality of different data message flows to identify data message flows with degraded performance.

10. The method of claim 8 further comprising correlating flow statistics from a first network element with flow statistics from a second element based on flow identification information.

11. The method of claim 10, wherein the flow identification information comprises a 5-tuple, the 5-tuple comprising source and destination network addresses, source and destination transport layer ports, and a transport layer protocol.

12. The method of claim 1, wherein identifying the data message flow comprises analyzing sets of flow statistics received for a plurality of data message flows to identify data message flows with degraded performance.

13. The method of claim 1, wherein identifying the data message flow with degraded performance comprises determining that a particular metric passes a threshold value.

14. The method of claim 1, wherein identifying the data message flow with degraded performance comprises:
over a first period of time, analyzing a third set of flow statistics for the data message flow to identify a baseline for a particular metric for the data message flow; and
determining from the first set of flow statistics that the particular metric for the data message flow has deviated from the identified baseline by at least a threshold amount.

15. A non-transitory machine-readable medium storing a program which when executed by at least one processing unit manages a network, the program comprising sets of instructions for:
based on a first set of flow statistics received from a plurality of network elements in the network, identifying a data message flow with degraded performance, the data message flow following a path between a first endpoint and a second endpoint through a set of the network elements in the network, the path comprising a plurality of segments;
using a second set of flow statistics received from the set of network elements to identify a particular segment of the path as a most likely contributor to the degraded performance of the particular flow; and
initiating a corrective action to resolve the degraded performance for the data message flow based on the identification of the particular segment.

16. The non-transitory machine-readable medium of claim 15, wherein the data message flow is a bidirectional flow.

17. The non-transitory machine-readable medium of claim 16, wherein the first set of flow statistics received from a particular network element comprises at least one of round trip time between the particular network element and the first endpoint, round trip time between the particular network element and the second endpoint, a number of data messages belonging to the data message flow received by the particular network element that were sent from the first endpoint, a number of data messages belonging to the data message flow received by the particular network element that were sent from the second endpoint, a number of retransmitted data messages belonging to the data message flow received by the particular element that were sent from the first endpoint, and a number of retransmitted data messages belonging to the data message flow received by the particular element that were sent from the second endpoint.

18. The non-transitory machine-readable medium of claim 1, wherein the data message flow is a unidirectional flow.

19. The non-transitory machine-readable medium of claim 18, wherein the first set of flow statistics received from a particular network element comprises at least one of jitter for the data message flow, latency for the data message flow, and packet loss for the data message flow.

20. The non-transitory machine-readable medium of claim 15, wherein the set of instructions for using the second set of flow statistics to identify the particular segment comprises a set of instructions for computing metrics for each respective segment based at least on statistics received from one or more respective network elements that are segment endpoints for the respective segment.

21. The non-transitory machine-readable medium of claim 20, wherein the computed metrics comprise differences in round trip time between (i) a first network element and the first endpoint and (ii) a second network element and the first endpoint.

22. The non-transitory machine-readable medium of claim 20, wherein computing metrics for each respective segment enables isolation of the particular segment with degraded performance.

23. The non-transitory machine-readable medium of claim 15, wherein the set of instructions for initiating corrective action comprises a set of instructions for providing a notification to an administrator regarding the particular segment.

24. The non-transitory machine-readable medium of claim 23, wherein the notification specifies an application to which the data message flow relates and a name for the particular segment.

25. The non-transitory machine-readable medium of claim 15, wherein the set of instructions for initiating corrective action comprises a set of instructions for automatically modifying the path through the network for the data message flow.

26. The non-transitory machine-readable medium of claim 25, wherein the set of instructions for automatically modifying the path comprises a set of instructions for choosing a third, different endpoint to replace the second endpoint, wherein the third endpoint performs a same function at a different location as the replaced second endpoint.

27. The non-transitory machine-readable medium of claim 25, wherein the set of instructions for automatically modifying the path comprises a set of instructions for modifying a priority of the data messages of the data message flow.

28. The non-transitory machine-readable medium of claim 25, wherein the set of instructions for automatically modifying the path comprises a set of instructions for directing the data message flow along a new path that comprises at least one network element that was not in the path with degraded performance.

29. The non-transitory machine-readable medium of claim 25, wherein the set of instructions for initiating corrective action comprises a set of instructions for automatically increasing an allowed bandwidth for the data message flow.
